(19) United States
(12) Patent Application Publication
(10) Pub. No.: US 2006/0125654 A1
(43) Pub. Date: Jun. 15, 2006

(54) Vehicle accident warning system

(76) Inventors: Jung-Huang Liao, Hsinchu (TW); Tao-Pang Hsiung, Chupei city (TW)

Correspondence Address: PRO-TECHTOR INTERNATIONAL, 20775 Norada Court, Saratoga, CA, 95070-3018, US

(21) Appl. No.: 11/034,661

(22) Filed: Jan. 12, 2005

(30) Foreign Application Priority Data
Dec. 1, 2004 (TW) SN.093137106

(51) Int. Cl. G08G 1/00

(52) U.S. Cl. 340/902

(57) ABSTRACT

A vehicle accident warning system comprises a sensor, detecting an external acoustic signal; an identifying device, receiving a signal from said sensor according to said acoustic signal and performing analysis of frequency and repetition rate thereof for identifying said signal as a warning signal; and a controlling device, receiving an identification signal from said identifying device according to said analysis thereof and issuing a corresponding alerting message.

### BACKGROUND OF THE INVENTION

1. Field of the Invention

The present invention relates to a vehicle accident warning system, particularly to a vehicle accident warning system which is self-contained, upon installation in a vehicle does not need a change in design thereof or impair driving experience, and is capable of alerting a driver to imminent danger.

2. Description of Related Art

During driving, music and radio or TV programs are often played at too high a volume. In addition, effective insulation of sound by car windows block acoustic signals from outside, like sirens of police cars, ambulances or fire engines, or warning signals from railway crossings. Inattentiveness to warning signals possibly results in serious, even fatal accidents.

U.S. Pat. No. 6,690,291 “Vehicle hazard warning system” and patent application file no. 2000-404620 “Apparatus of automatically lowering sound volume of audio apparatus by sensing sirens and warning sounds of fire engines, ambulance, police cars, crossing gates and the like” disclose apparatuses that receive radio frequency and acoustic signals and identify these as external warning signals. However, these conventional devices often generate false alarms which subsequently cause loudspeakers in the vehicle to lower volume, without a specific or friendly-sounding alert being issued. Furthermore, these conventional devices do not provide for manual or automatic resetting of the vehicle's audio and video system and do not allow for wireless operation. Therefore, conventional vehicle hazard warning systems still are not convenient to use and fail to prevent traffic hazards.

### SUMMARY OF THE INVENTION

It is an object of the present invention to provide a vehicle accident warning system having an improved identification device for generating alarms based on repetition rates of received sounds, so as to avoid false alarms.

Another object of the present invention is to provide a vehicle accident warning system which, upon a generated alarm, issues a friendly-sounding alert message.

A further object of the present invention is to provide a vehicle accident warning system which, after having issued an alerting message, resets the audio and video system of the car into an original state.

A further object of the present invention is to provide a vehicle accident warning system which allows for wireless data transmission between a receiving and an identifying device.

A further object of the present invention is to provide a vehicle accident warning system which allows for various repetition rates of external acoustic signals to be identified as warning signals.

The present invention can be more fully understood by reference to the following description and accompanying drawings.

### DETAILED DESCRIPTION OF THE PREFERRED EMBODIMENTS

The vehicle accident warning system of the present invention is installed in a vehicle a self-contained system, requiring no changes in the structure of the vehicle and not impairing comfort of driver and passengers.

Regardless of wired or wireless operation, like a receiving device working according to various standards, the present invention is capable of sieving out from dozens or hundreds of frequencies and characteristics warning signals. Upon identification of a warning signal, a running radio or audio program is interfered with and turned down in volume or completely stopped. Then, according to the kind of warning signal identified, an alerting message is issued, like “Attention please, a fire engine is coming near”, “Attention please, a police car is coming near”, “Attention please, an ambulance is coming near” or “Attention please, you are approaching a crossing gate”. The alerting message is repeated several times. Then the radio or audio program is manually, by pressing a button, or automatically resumed. Thereby driver and passenger are able to enjoy a radio or audio program without worrying to miss a warning signal from outside that is blocked by well-insulating windows. The value of the vehicle as well as safety of driver and passengers are preserved.

As shown in FIG. 1, the vehicle accident warning system of the present invention, in a first embodiment operating with wires for data transmission, has a sensor 400, which is installed on a roof of a vehicle at a suitable position for receiving acoustic signals of certain frequencies (like of fire engines, police cars, ambulances and crossing gates). The detected signal is transmitted via a signal cable 300 to a receiver 200 (including an identifying device 210 and a controlling device 250, as shown in FIG. 2) and undergoes analysis for identification as a warning signal of a certain type. After identification, volume of an audio system inside the vehicle is turned down or audio operation is stopped, and an alerting message that is stored in the receiver 200 is issued. In the first embodiment of the present invention, a power cable 100 with end connectors 101 and 102 is used, which are connected with a cigarette lighter and a socket on the receiver 200, respectively, so that the receiver 200 and the sensor 400 are supplied with electricity from the vehicle. A direct connection with a power circuit of the vehicle or battery operation of the sensor 400 are also possible.

FIG. 2 is a flowchart of operation of the present invention. The sensor 400 detects an external acoustic signal. The detected signal is transmitted via the signal cable 300 to the identifying device 210. The identifying device 210 comprises an amplifier 215, a filter 220, an identifier 220 and a timer 240. The amplifier 215 amplifies the signal, and the filter 220 filters out noise, then the signal is sent to the identifier 230. There frequency changes of the signal are sensed and repetition rates of the signal are recognized using the timer 240. An identification signal is sent to the controlling device 250. The controlling device 250 has a controller 270 receiving the identification signal from the identifier 230. Upon receiving an identification signal, the controller 270 drives audio/video devices 260 to lower volume or to stop operating. Then a sound generator 280 is driven to issue an alerting signal depending on the identification signal received, like “Attention please, a fire engine is coming near”, “Attention please, a police car is coming near”, “Attention please, an ambulance is coming near” or “Attention please, you are approaching a crossing gate”.

The present invention allows the audio/video devices 260 to resume previous operation automatically after issuing the alerting message or manually by having a button pressed. The timer 240 deactivates re-issuing an alerting message for a preset time, e.g., 30 seconds or one minute to avoid confusion by repeated issuing of alerting messages.

The connecting ends 101, 102 of the power cable 100 are connected with a cigarette lighter and a socket on the receiver 200, respectively, so that the receiver 200 and the sensor 400 are supplied with electricity from the vehicle. Battery operation of the sensor 400 is also possible.

The present invention in a second embodiment allows for wireless data transmission. Referring to FIG. 3, a sensor 401 having a wireless transmitter is mounted on the roof of the vehicle. A detected acoustic signals of certain frequencies is wirelessly transmitted to a receiver 201 (including an identifying device 210 and a controlling device 250, as shown in FIG. 4) and undergoes analysis for identification as a warning signal of a certain type.

FIG. 4 is a flowchart of wireless operation of the present invention. The sensor 401 detects an external acoustic signal. The detected signal is wirelessly transmitted to an amplifier 215 of the identifying device 210 for being amplified. The sensor 401 is powered by a battery. Further structural parts of the second embodiment of the present invention are the same as those of the first embodiment shown in FIG. 2 and do not need further explanation.

The present invention operates independent of the vehicle and can be purchased and installed separately, with the signal cable 300 being laid along the roof of the vehicle or wireless operation being chosen. Power is supplied by the cigarette lighter or another direct current source.

Decreeing the vehicle accident warning system of the present invention as required installation in vehicles not only reduces accidents, but also clearly points out responsibilities for accidents caused by drivers crossing closed crossing gates or not yielding to emergency vehicles.

While the invention has been described with reference to preferred embodiments thereof, it is to be understood that modifications or variations may be easily made without departing from the spirit of this invention which is defined by the appended claims.

### BRIEF DESCRIPTION OF THE DRAWINGS

FIG. 1 is a schematic illustration of the vehicle accident warning system of the present invention in the first embodiment.

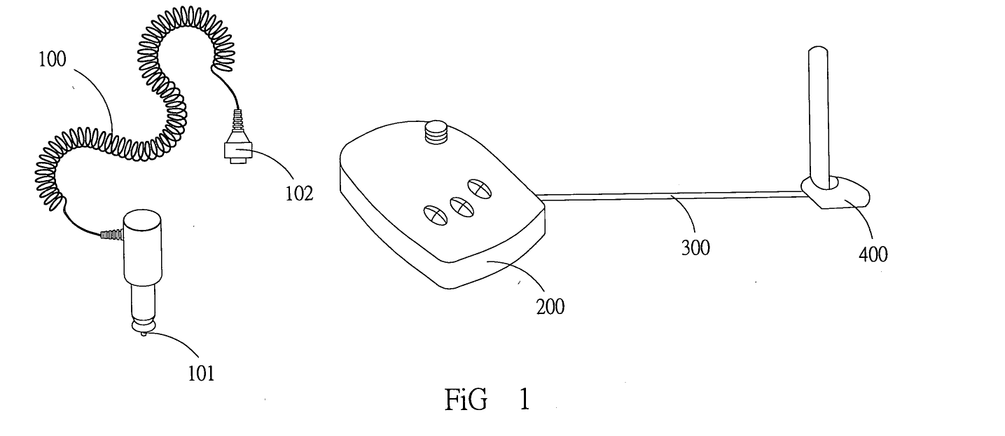

FIG. 2 is a flowchart showing operation of the present invention in the first embodiment.

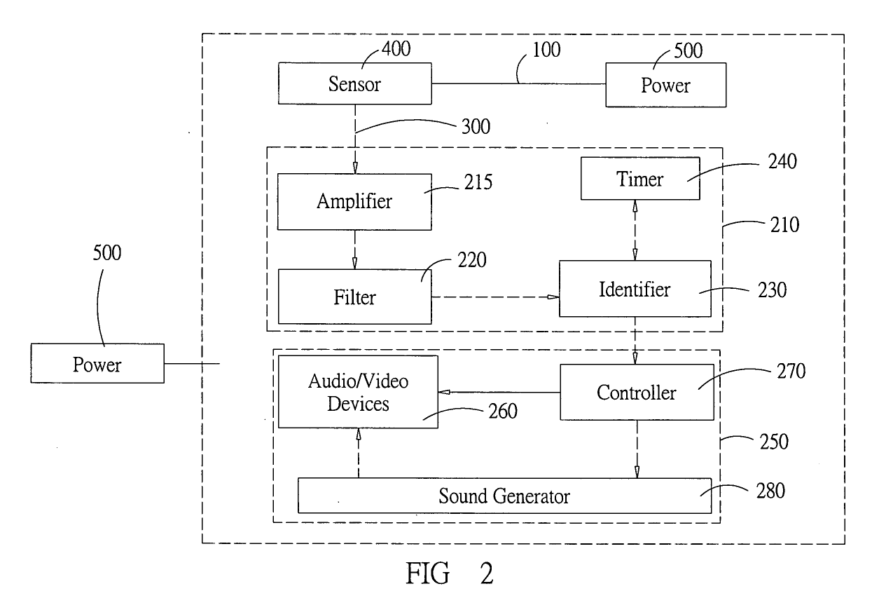

FIG. 3 is a schematic illustration of the vehicle accident warning system of the present invention in the second embodiment.

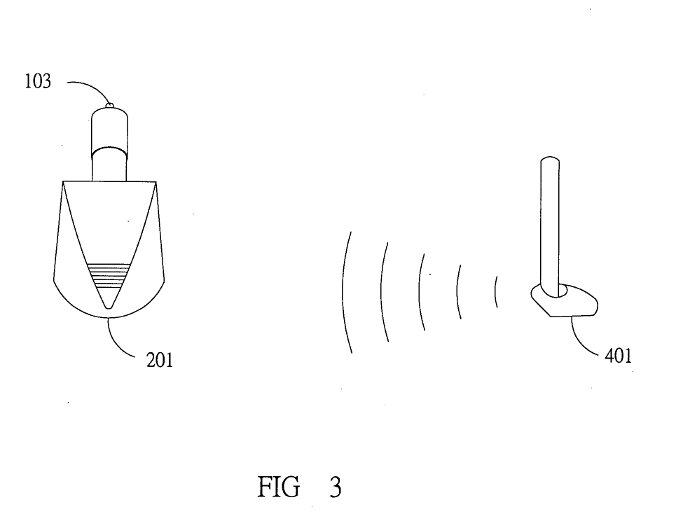

FIG. 4 is a flowchart showing operation of the present invention in the second embodiment.

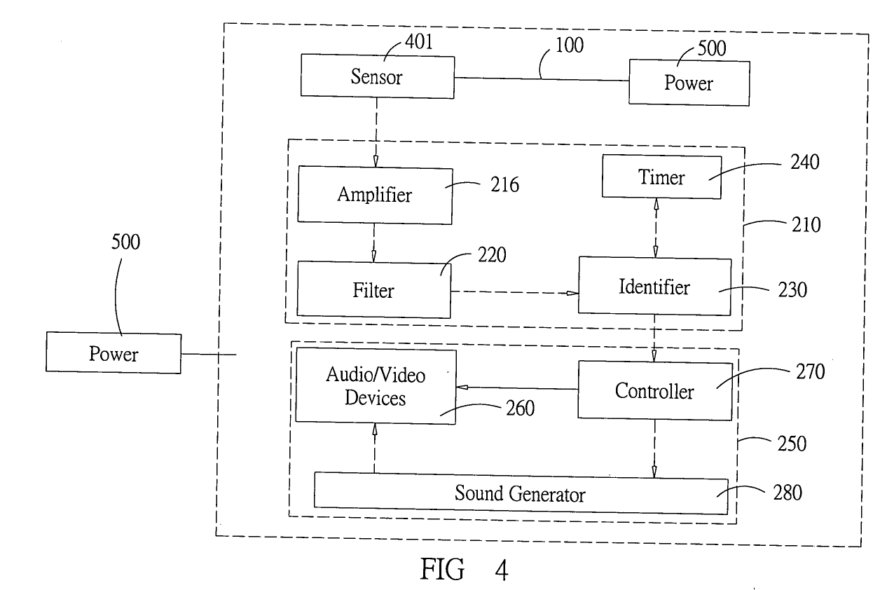

1. A vehicle accident warning system, installed in a vehicle, comprising:
a sensor, detecting an external acoustic signal;
an identifying device, receiving a signal from said sensor according to said acoustic signal and performing analysis of frequency and repetition rate thereof for identifying said signal as a warning signal; and
a controlling device, receiving an identification signal from said identifying device according to said analysis thereof and issuing a corresponding alerting message.

2. The vehicle accident warning system according to claim 1, wherein said signal is transmitted by a signal wire from said sensor to said identifying device.

3. The vehicle accident warning system according to claim 1, wherein said signal is transmitted wirelessly from said sensor to said identifying device.

4. The vehicle accident warning system according to claims 2, wherein said identifying device comprises:
an amplifier, amplifying said signal;
a filter, filtering out noise from said signal after amplification; and
an identifier, analyzing said signal and sending an identification signal to said controlling device.

5. The vehicle accident warning system according to claims 3, wherein said identifying device comprises:
an amplifier, amplifying said signal;
a filter, filtering out noise from said signal after amplification; and
an identifier, analyzing said signal and sending an identification signal to said controlling device.

6. The vehicle accident warning system according to claim 4, wherein said identifying device further comprises a timer for supporting said analysis of said signal.

7. The vehicle accident warning system according to claims 5, wherein said controlling device comprises:
audio/video devices, issuing an alerting message; and
a controller, receiving said identification signal from said identifying device and driving said audio/video devices to issue an according alerting message.

8. The vehicle accident warning system according to claims 6, wherein said controlling device comprises:
audio/video devices, issuing an alerting message; and
a controller, receiving said identification signal from said identifying device and driving said audio/video devices to issue an according alerting message.

9. The vehicle accident warning system according to claims 2, wherein said controlling device comprises:
audio/video devices, issuing an alerting message; and
a controller, receiving said identification signal from said identifying device and driving said audio/video devices to issue an according alerting message.

10. The vehicle accident warning system according to claims 3, wherein said controlling device comprises:
audio/video devices, issuing an alerting message; and
a controller, receiving said identification signal from said identifying device and driving said audio/video devices to issue an according alerting message.

11. The vehicle accident warning system according to claim 9, wherein said controlling device further comprises a sound generator, generating an alerting message as driven by said controller.

12. The vehicle accident warning system according to claim 10, wherein said controlling device further comprises a sound generator, generating an alerting message as driven by said controller

13. The vehicle accident warning system according to claim 1, wherein a power cable connects a cigarette lighter and said identifying device.

14. The vehicle accident warning system according to claim 13, wherein said sensor is powered by a battery or directly supplied by a power circuit of said vehicle.

15. The vehicle accident warning system according to claim 1, wherein, after an alerting message has been issued, as driven by said controlling device, normal operation of audio/video devices is resumed automatically or manually by pressing a button.

16. The vehicle accident warning system according to claim 1, wherein, after an alerting message has been issued, re-issuing of said alerting message is suppressed for a preset time.
